(19) United States
(12) Patent Application Publication
(10) Pub. No.: US 2008/0226831 A1
(43) Pub. Date: Sep. 18, 2008

(54) PROCESS FOR DIFFUSING TITANIUM AND NITRIDE INTO A STEEL OR STEEL ALLOY BY ALTERING THE CONTENT OF SUCH

(76) Inventors: Philos Jongho Ko, Barrington, IL (US); Bongsub Samuel Ko, Barrington, IL (US)

Correspondence Address: LAW OFFICES OF EUGENE M. CUMMINGS, P.C., ONE NORTH WACKER DRIVE, SUITE 4130, CHICAGO, IL, 60606, US

(21) Appl. No.: 11/869,399

(22) Filed: Oct. 9, 2007

Related U.S. Application Data
(60) Provisional application No. 60/828,547, filed on Oct. 6, 2006.

(51) Int. Cl. B32B 5/14; B05D 1/18

(52) U.S. Cl. 427/435; 428/610

(57) ABSTRACT

An improved method is provided for diffusing titanium and nitride into a base material comprising a steel or steel alloy. The composition of the base material generally comprises at least one of the following: more than about 1.95% vanadium, less than about 4.1% chromium, and a presence of cobalt. The method generally includes the steps of providing such a base material; providing a salt bath which includes sodium dioxide and a salt selected from the group consisting of sodium cyanate and potassium cyanate; dispersing metallic titanium formed by electrolysis of a titanium compound in the bath; heating the salt bath to a temperature ranging from about 430° C. to about 670° C.; and soaking the base material in the salt bath for a time of from about 10 minutes to about 24 hours.

### CROSS-REFERENCE TO RELATED APPLICATIONS

This application claims benefit under 35 U.S.C. §119(e) of U.S. Provisional Application Ser. No. 60/828,547, entitled “IMPROVED PROCESS FOR DIFFUSING TITANIUM AND NITRIDE INTO A STEEL OR STEEL ALLOY BY ALTERING THE CONTENT OF SUCH,” filed Oct. 6, 2006, naming Philos Jongho Ko and Bongsub Samuel Ko as the inventors, the complete disclosure being incorporated herein by reference.

### BACKGROUND OF THE INVENTION

The present invention generally relates to a process for diffusing titanium and nitride into a steel or steel alloy. More specifically, an improved process is provided for diffusing titanium and nitride into a steel or steel alloy by altering the content of such.

The present invention relates to a low temperature process for diffusing titanium and nitride into a steel or steel alloy in the presence of electrolyzed titanium. A low temperature process is preferred in that it prevents or lessens warping and twisting of the material, two disadvantages of conventional surface treatment processes. Titanium is generally known as a generally inert, light-weight material which has very high tensile strength (or toughness) and excellent corrosion resistance. Accordingly, because of their inert nature, increased hardness, increased tensile strength and increased resistance to wear, steel or steel alloy products diffused with titanium and nitride may be used in various applications including industrial, biomedical, aerospace, defense, automotive, jewelry, tools, tool-making, gun-making applications and other such applications.

U.S. Pat. No. 6,645,566, which is incorporated by reference herein and made a part hereof, describes a process for diffusing titanium and nitride into a variety of base materials including steel and steel alloys, aluminum and aluminum alloys, titanium and titanium alloys. U.S. Pat. No. 6,645,566 describes various embodiments for increasing the effectiveness of the process described therein by manipulation of the process itself, but not by the altering of the content of the base material to be treated.

Because the process as described in U.S. Pat. No. 6,645,566 requires the use of a large quantity of chemicals and numerous processing conditions, it is often burdensome to manipulate such process to achieve optimal effectiveness for each type of base material to be treated. It would, therefore, be desired to increase the effectiveness of the process as described in U.S. Pat. No. 6,645,566 without the manipulation of such process, but rather through the altering of the content of the base material to be treated. As such, a base material having a desired composition may be simply provided to increase the effectiveness of the aforementioned process, without manipulation of the process itself.

Accordingly, it is an object of the invention to improve the effectiveness of the process as described in U.S. Pat. No. 6,645,566 by altering the content of the base material to be treated.

It is further an object of the present invention to improve the effectiveness of the process as described in U.S. Pat. No. 6,645,566 by altering the content of a steel or steel alloy to be treated.

These and other desired benefits of the preferred embodiments, including the combinations of features thereof, of the invention will become apparent from the following description. It will be understood, however, that a process or arrangement could still appropriate the claimed invention without accomplishing each and every one of these desired benefits, including those gleaned from the following description. The appended claims, not these desired benefits, define the subject matter of the invention. Any and all benefits are derived from the multiple embodiments of the invention, not necessarily the invention in general.

### SUMMARY OF THE INVENTION

In view of the desired goals of the invention claimed herein, an improved method is provided for diffusing titanium and nitride into a base material comprising a steel or steel alloy. U.S. Pat. No. 6,645,566 specifically describes a method for diffusing titanium and nitride into steel and steel alloys, specifically SKS, SUS304, SKH-9, SUS, 420J2, S35C, SCM4, SKD-11, SKD-61, SACM1, S25C, S45C, SS41, SK, SKS, SCM, SNC, and D2. Steel and steel alloys generally comprise iron, carbon and, in some instances, other elements. The various embodiments of the present invention improve this process by altering the content of various elements within the steel or steel alloy, rather than manipulating the process as described in U.S. Pat. No. 6,645,566. More specifically, the process as described in U.S. Pat. No. 6,645,566 may be improved by altering the composition of the steel or steel alloy base material to comprise at least one of the following: more than about 1.95% vanadium, less than about 4.1% chromium, and a presence of cobalt.

Accordingly, the present invention method generally includes the steps of providing a steel or steel alloy base material. A steel or steel alloy base material is provided or altered such that it comprises at least one of the following: more than about 1.95% vanadium, less than about 4.1% chromium, and at least a presence of cobalt. A salt bath is provided which includes sodium dioxide and a salt selected from the group consisting of sodium cyanate and potassium cyanate. Metallic titanium formed by electrolysis of a titanium compound is dispersed in the bath. The salt bath is heated to a temperature ranging from about 430° C. to about 670° C. The altered base material is soaked in the salt bath for a time of from about 10 minutes to about 24 hours.

In accordance with yet another aspect of the invention, further provided is a treated article comprising a steel or steel alloy base material having a titanium component diffused therein and comprising at least one of the following: more than about 1.95% vanadium, less than about 4.1% chromium, and at least a presence of cobalt. The treated article is generally produced by the aforementioned process.

It should be understood that the present invention includes a number of different aspects or features which may have utility alone and/or in combination with other aspects or features. Accordingly, this summary is not exhaustive identification of each such aspect or feature that is now or may hereafter be claimed, but represents an overview of certain aspects of the present invention to assist in understanding the more detailed description that follows. The scope of the invention is not limited to the specific embodiments described below, but is set forth in the claims now or hereafter filed.

### BRIEF DESCRIPTION OF THE SEVERAL VIEWS OF THE DRAWINGS

Throughout this description, reference has been and will be made to the accompanying views of the drawing wherein like subject matter has like reference numerals, and wherein:

FIG. 1 is a scanning electron micrograph cross-sectional view of a steel article treated with the titanium and nitride diffusion process as described in U.S. Pat. No. 6,645,566;

FIG. 2 is a scanning electron micrograph cross-sectional view of an altered steel treated with the titanium and nitride diffusion process in accordance with an aspect of the present invention; and

FIG. 3 is a scanning electron micrograph cross-sectional view of another altered steel treated with the titanium and nitride diffusion process in accordance with an aspect of the present invention.

### DETAILED DESCRIPTION OF THE MULTIPLE EMBODIMENTS

While the invention is susceptible of embodiment in many different forms and in various combinations, particular focus will be on the multiple embodiments of the invention described herein with the understanding that such embodiments are to be considered exemplifications of the principles of the invention and are not intended to limit the broad aspect of the invention.

In one embodiment of the present invention, a moderately heated non-electrolyzed salt bath is used which contains activated-electrolyzed metallic titanium. Sodium dioxide and a salt selected from the group consisting of sodium cyanate and potassium cyanate, in amounts of from about 80 to about 85 w/w %, is present in the salt bath with from about 15 to about 20 w/w % of NaCO₂, NaCO₃, Na₂CO₃, or sodium chloride. To the bath is added from about 2 to about 20 micrograms of electrolyzed metallic titanium. A base metal material is soaked in the bath for from about 10 minutes to 24 hours at from about 430° C. to about 670° C. The electrolyzed titanium catalyzes the diffusion of the titanium and nitride from the bath into about 20 to about 100 microns of the base metal.

A steel or steel alloy base material having a desired composition may be provided or altered to increase the effectiveness of the aforementioned process, without manipulation of the process itself. For example, by altering the content of the steel or steel alloy base material, the effectiveness of the process as described in U.S. Pat. No. 6,645,566 may be improved. For example, vanadium and cobalt may be added to the steel or steel alloy base material to enhance the diffusion of titanium and nitride into such, whereas chromium may be added to inhibit the diffusion of titanium and nitride into the base material.

More specifically, in one embodiment, vanadium may be added to a steel or steel alloy in order cause deeper and more even diffusion of titanium and nitride therein. Vanadium is added such that the composition of the steel or steel alloy includes more than about 1.95% vanadium, preferably about 2.5% to about 4.5% vanadium. In another embodiment, cobalt may be added to a steel or steel alloy in order cause deeper and more even diffusion of titanium and nitride therein. Cobalt is added such that the composition of the steel or steel alloy includes more than about 2% cobalt, preferably about 2% to about 14% cobalt. In yet another embodiment, the amount of chromium may be limited in order cause deeper and more even diffusion of titanium and nitride therein. Chromium is limited such that the composition of the steel or steel alloy includes less than about 4.1% chromium, preferably about 2% to about 3.8% chromium.

Steel or steel alloys having one or more of the above preferred characteristics generally include, but are not limited to, M3 and higher grade high speed steels (e.g., M3, M4, M7, M35, M42, M48, and M62); T4 and higher grade high speed steels (e.g., T4, T8, and T15); higher grade hot forming and die casting steels including H10, H11, H12, H19, H21, P20, Shell-X, FX, and CX; and cold forming steels (e.g., Sleipner and DC53). Surprisingly, it was found that using these altered steel or steel alloys in lieu of those noted and described in the U.S. Pat. No. 6,645,566 increased the effectiveness of the above process, namely titanium and nitride diffused more deeply and more evenly into such. More specifically, increasing the amount of vanadium and/or cobalt in the steel or steel alloy facilitates the diffusion of titanium and nitride into the base material. Limiting the amount of chromium in the steel or steel alloy base material also facilitates the diffusion of titanium and nitride into the base material. However, altering the amount of other elements commonly found in steel alloys (e.g., tungsten, molybdenum, etc.) did not similarly alter the effectiveness of the process.

One embodiment of the present invention includes a method for diffusing titanium and nitride into an altered steel or steel alloy base metal material as described above comprising the following steps: providing a altered steel or steel alloy base metal material, providing a salt bath which includes sodium dioxide and a salt selected from the group consisting of sodium cyanate and potassium cyanate, dispersing electrolyzed metallic titanium in said bath, heating the salt bath to a temperature ranging from about 430° C. to about 670° C.; and soaking the material in the salt bath for a time of from about 10 minutes to 24 hours, and preferably from about 2 to about 10 hours. Preferably, the salt bath includes from about 15 to about 20 w/w % of an added salt selected from the group consisting of sodium carbon dioxide, sodium carbonate, and sodium chloride. The soaking temperature advantageously ranges from about 500° C. to about 650° C., preferably from about 530° C. to about 630° C.

Through this process, titanium and nitride are diffused into the altered steel or steel alloy base metal. Surprisingly, it was found that using these steel or steel alloys in lieu of those noted and described in the U.S. Pat. No. 6,645,566 increased the effectiveness of the above process, namely titanium and nitride diffused more deeply and more evenly into the altered steel or steel alloys.

Moreover, U.S. Pat. No. 6,645,566 describes soaking the base material from about 2 hours to about 10 hours, and preferably about 2 hours to about 6 hours. This soaking time is generally sufficient for ample diffusion of titanium and nitride into the specific types of steel, aluminum and titanium described therein. However and surprisingly, it is found that diffusion for the altered steel or steel alloy may occur as soon as 10 minutes into the soaking process. Furthermore, it is preferable to increase the time in which the base metal material is soaked in the bath in order to facilitate the diffusion of titanium and nitride therein.

### EXAMPLE 1

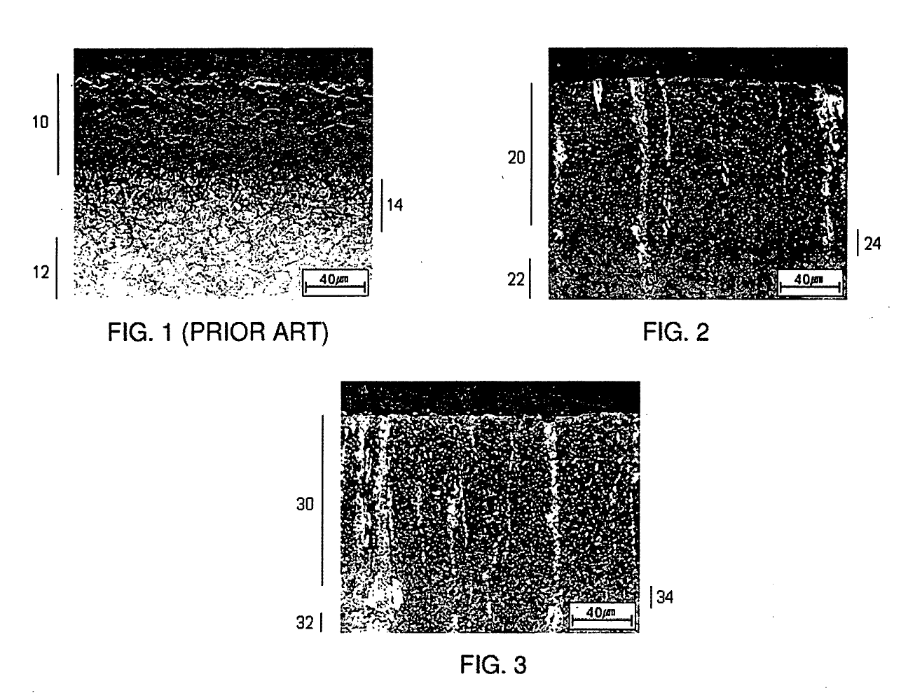

FIG. 1 illustrates a steel article treated with the titanium and nitride diffusion process as described in U.S. Pat. No. 6,645,566. The pretreated steel generally includes about 0.9% vanadium and about 12% chromium. Steels having this composition are generally referred in the art as D2 type steels.

The steel article is soaked in a moderately heated non-electrolyzed salt bath is used which contains activated-electrolyzed metallic titanium. Sodium dioxide and a salt selected from the group consisting of sodium cyanate and potassium cyanate, in amounts of from about 80 to about 85 w/w %, is present in the salt bath with from about 15 to about 20 w/w % of NaCO₂, NaCO₃, Na₂CO₃, or sodium chloride. To the bath is added from about 2 to about 20 micrograms of electrolyzed metallic titanium. The steel article is soaked in the bath for from about 6 hours at from about 430° C. to about 670° C. The electrolyzed titanium catalyzes the diffusion of the titanium and nitride from the bath into about 20 to about 100 microns of the steel article.

As shown in FIG. 1, the diffusion of titanium and nitride is shown as the previously lighter material is now darker. The darkness corresponds to titanium and nitride filling the voids among the grains of the steel structure. As such, a diffused layer 10 (e.g., where titanium and nitride has diffused into the steel article) and an undiffused layer 12 (e.g., where titanium and nitride is not diffused into the steel article) are shown. The diffusion layer 10 is shown to be about 65 μm. It is to be noted that the transition 14 between the diffused layer and undiffused layer is rather abrupt as depicted by the contrast between light and dark. Moreover, the transition 14 generally comprises a plurality of roots.

### EXAMPLE 2

FIG. 2 illustrates a steel article treated with the titanium and nitride diffusion process in accordance with an aspect of the present invention. The content of the steel article is altered such that there is an increase in vanadium content to about 1.95% vanadium, while also limiting the chromium content to about 4.1% chromium. Steels having this composition are generally known in the art as M2 type steels. Although M2 type steels are described in U.S. Pat. No. 6,645,566, it is shown herein that increasing the vanadium content in the steel or steel alloy increases the effectiveness of the process. It is further shown in this embodiment that limiting the chromium content in the steel or steel alloy also increases the effectiveness of the process. It is to be noted that M3 and higher grade high speed steels generally contain a higher vanadium content and a lower chromium content than M2 type steels.

The altered steel article is treated under similar conditions as the process described in Example 1. More specifically, the altered steel article is soaked in a moderately heated non-electrolyzed salt bath is used which contains activated-electrolyzed metallic titanium. Sodium dioxide and a salt selected from the group consisting of sodium cyanate and potassium cyanate, in amounts of from about 80 to about 85 w/w %, is present in the salt bath with from about 15 to about 20 w/w % of NaCO₂, NaCO₃, Na₂CO₃, or sodium chloride. To the bath is added from about 2 to about 20 micrograms of electrolyzed metallic titanium. The altered steel article is soaked in the bath for about 6 hours at from about 430° C. to about 670° C. The electrolyzed titanium catalyzes the diffusion of the titanium and nitride from the bath into about 20 to about 100 microns of the altered steel article.

As shown in FIG. 2, the diffusion of titanium and nitride is shown as the previously lighter material is now darker. The darkness corresponds to titanium and nitride filling the voids among the grains of the steel structure. As such, a diffused layer 20 (e.g., where titanium and nitride has diffused into the steel article) and an undiffused layer 22 (e.g., where titanium and nitride is not diffused into the steel article) are shown.

Within the same soaking time of about 6 hours, titanium and nitride diffused deeper into the altered steel of FIG. 2 (about 100 μm) as compared to the steel of FIG. 1 (about 65 μm). This is generally shown as the diffused layer 20 of FIG. 2 is generally larger than the diffused layer 10 of FIG. 1.

It is also to be noted that the transition 24 between the diffused layer 20 and undiffused layer 22 is more even as depicted by the contrast between light and dark. For example, the diffused layer 20 is shown as slowly progressing to an undiffused layer 22 (e.g, transition from dark to light), rather than having an abrupt transition 14 as shown in FIG. 1. The transition 24 between the diffused layer 20 and undiffused layer 22 of FIG. 2 further shows an absence of roots, which further signifies deeper and more even diffusion.

### EXAMPLE 3

FIG. 3 illustrates a steel article treated with the titanium and nitride diffusion process in accordance with an aspect of the present invention. The content of the steel article is altered such that there is an increase in vanadium content to about 4% vanadium, while also limiting the chromium content to about 4% chromium. Steels having this composition are generally known in the art as M4 type steels.

The altered steel article is treated under similar conditions as the process described in Examples 1 and 2. More specifically, the altered steel article is soaked in a moderately heated non-electrolyzed salt bath is used which contains activated-electrolyzed metallic titanium. Sodium dioxide and a salt selected from the group consisting of sodium cyanate and potassium cyanate, in amounts of from about 80 to about 85 w/w %, is present in the salt bath with from about 15 to about 20 w/w % of NaCO₂, NaCO₃, Na₂CO₃, or sodium chloride. To the bath is added from about 2 to about 20 micrograms of electrolyzed metallic titanium. The altered steel article is soaked in the bath for about 6 hours at from about 430° C. to about 670° C. The electrolyzed titanium catalyzes the diffusion of the titanium and nitride from the bath into about 20 to about 100 microns of the altered steel article.

As shown in FIG. 3, the diffusion of titanium and nitride is shown as the previously lighter material is now darker. The darkness corresponds to titanium and nitride filling the voids among the grains of the steel structure. As such, a diffused layer 30 (e.g., where titanium and nitride has diffused into the steel article) and an undiffused layer 32 (e.g., where titanium and nitride is not diffused into the steel article) are shown.

Within the same soaking time of about 6 hours, titanium and nitride diffused deeper into the altered steel of FIG. 3 (about 120 μm) as compared to the altered steel of FIG. 2 (about steel 100 μm) and the steel of FIG. 1 (about 65 μm). This is generally shown as the diffused layer 30 of FIG. 3 is generally larger than the diffused layer 20 of FIG. 2 or the diffused layer 10 of FIG. 1.

It is also to be noted that the transition 34 between the diffused layer 30 and undiffused layer 32 is more even as depicted by the contrast between light and dark. For example, the diffused layer 30 is shown as slowly progressing to an undiffused layer 32 (e.g, transition from dark to light), rather than having an abrupt transition 34 as shown in FIG. 1. The transition 34 between the diffused layer 30 and undiffused layer 32 of FIG. 3 further shows an absence of roots, which further signifies deeper and more diffusion.

### EXAMPLE 4

The composition of a steel article was altered such that the content of vanadium was increased from under 1.95% vanadium to over 4% vanadium. The altered steel article is treated under similar conditions as the process described in Examples 1-3. More specifically, the altered steel article is soaked in a moderately heated non-electrolyzed salt bath is used which contains activated-electrolyzed metallic titanium. Sodium dioxide and a salt selected from the group consisting of sodium cyanate and potassium cyanate, in amounts of from about 80 to about 85 w/w %, is present in the salt bath with from about 15 to about 20 w/w % of NaCO₂, NaCO₃, Na₂CO₃, or sodium chloride. To the bath is added from about 2 to about 20 micrograms of electrolyzed metallic titanium. The altered steel article is soaked in the bath for about 6 hours at from about 430° C. to about 670° C. The electrolyzed titanium catalyzes the diffusion of the titanium and nitride from the bath into the surface of the altered steel article. An unaltered steel article is treated in the same matter. When comparing both articles after treatment, the treated altered article comprised more diffused titanium than the treated unaltered article.

### EXAMPLE 5

The composition of a steel article was altered such that the content of chromium was decreased from over 4.1% chromium to about 3.8% chromium. The altered steel article is treated under similar conditions as the process described in Examples 1-4. More specifically, the altered steel article is soaked in a moderately heated non-electrolyzed salt bath is used which contains activated-electrolyzed metallic titanium. Sodium dioxide and a salt selected from the group consisting of sodium cyanate and potassium cyanate, in amounts of from about 80 to about 85 w/w %, is present in the salt bath with from about 15 to about 20 w/w % of NaCO₂, NaCO₃, Na₂CO₃, or sodium chloride. To the bath is added from about 2 to about 20 micrograms of electrolyzed metallic titanium. The altered steel article is soaked in the bath for about 6 hours at from about 430° C. to about 670° C. The electrolyzed titanium catalyzes the diffusion of the titanium and nitride from the bath into the surface of the altered steel article. An unaltered steel article is treated in the same matter. When comparing both articles after treatment, the treated altered article comprised more diffused titanium than the treated unaltered article.

### EXAMPLE 6

The composition of a steel article was altered such that cobalt was added thereto such that there is about 8% cobalt. The altered steel article is treated under similar conditions as the process described in Examples 1-5. More specifically, the altered steel article is soaked in a moderately heated non-electrolyzed salt bath is used which contains activated-electrolyzed metallic titanium. Sodium dioxide and a salt selected from the group consisting of sodium cyanate and potassium cyanate, in amounts of from about 80 to about 85 w/w %, is present in the salt bath with from about 15 to about 20 w/w % of NaCO₂, NaCO₃, Na₂CO₃, or sodium chloride. To the bath is added from about 2 to about 20 micrograms of electrolyzed metallic titanium. The altered steel article is soaked in the bath for about 6 hours at from about 430° C. to about 670° C. The electrolyzed titanium catalyzes the diffusion of the titanium and nitride from the bath into the surface of the altered steel article. An unaltered steel article having no cobalt is treated in the same matter. When comparing both articles after treatment, the treated altered article comprised more diffused titanium than the treated unaltered article.

### EXAMPLE 7

The composition of a steel article was altered by varying the tungsten content. The altered steel article is treated under similar conditions as the process described in Examples 1-6. More specifically, the altered steel article is soaked in a moderately heated non-electrolyzed salt bath is used which contains activated-electrolyzed metallic titanium. Sodium dioxide and a salt selected from the group consisting of sodium cyanate and potassium cyanate, in amounts of from about 80 to about 85 w/w %, is present in the salt bath with from about 15 to about 20 w/w % of NaCO₂, NaCO₃, Na₂CO₃, or sodium chloride. To the bath is added from about 2 to about 20 micrograms of electrolyzed metallic titanium. The altered steel article is soaked in the bath for about 6 hours at from about 430° C. to about 670° C. The electrolyzed titanium catalyzes the diffusion of the titanium and nitride from the bath into the surface of the altered steel article. An unaltered steel article is treated in the same matter. When comparing both articles after treatment, the treated altered article comprised about the same amount of diffused titanium as the treated unaltered article.

### EXAMPLE 8

The composition of a steel article was altered by varying the molybdenum content. The altered steel article is treated under similar conditions as the process described in Examples 1-7. More specifically, the altered steel article is soaked in a moderately heated non-electrolyzed salt bath is used which contains activated-electrolyzed metallic titanium. Sodium dioxide and a salt selected from the group consisting of sodium cyanate and potassium cyanate, in amounts of from about 80 to about 85 w/w %, is present in the salt bath with from about 15 to about 20 w/w % of NaCO₂, NaCO₃, Na₂CO₃, or sodium chloride. To the bath is added from about 2 to about 20 micrograms of electrolyzed metallic titanium. The altered steel article is soaked in the bath for about 6 hours at from about 430° C. to about 670° C. The electrolyzed titanium catalyzes the diffusion of the titanium and nitride from the bath into the surface of the altered steel article. An unaltered steel article is treated in the same matter. When comparing both articles after treatment, the treated altered article comprised about the same amount of diffused titanium as the treated unaltered article.

Accordingly, the above examples show that increasing the amount of vanadium and/or cobalt in the steel or steel alloy facilitates the diffusion of titanium and nitride into the base material. Limiting the amount of chromium in the steel or steel alloy base material also facilitates the diffusion of titanium and nitride into the base material. In contrast, altering the amount of other elements commonly found in steel alloys (e.g., tungsten, molybdenum, etc.) did not similarly alter the effectiveness of the process.

While this invention has been described with reference to certain illustrative aspects, it will be understood that this description shall not be construed in a limiting sense. Rather, various changes and modifications can be made to the illustrative embodiments without departing from the true spirit, central characteristics and scope of the invention, including those combinations of features that are individually disclosed or claimed herein. Furthermore, it will be appreciated that any such changes and modifications will be recognized by those skilled in the art as an equivalent to one or more elements of the following claims, and shall be covered by such claims to the fullest extent permitted by law.

1. A method for diffusing titanium and nitride into a base material comprising:
providing a base material comprising a steel or steel alloy,
altering the composition of the base material such that the base material comprises more than about 1.95% vanadium;
providing a salt bath which includes sodium dioxide and a salt selected from the group consisting of sodium cyanate and potassium cyanate;
dispersing metallic titanium formed by electrolysis of a titanium compound, in said bath;
heating the salt bath to a temperature ranging from about 430° C. to about 670° C.; and
soaking the material in the salt bath for a time of from about 10 minutes to about 24 hours.

2. The method of claim 1 further comprising the step of increasing the amount of vanadium in the base material in order to facilitate diffusion of titanium and nitride into the base material.

3. The method of claim 1 further comprising the step of altering the composition of the base material such that the base material further comprises cobalt, and wherein the presence of cobalt in the base material facilitates the diffusion of titanium and nitride into the base material.

4. The method of claim 1 further comprising the step of limiting the amount of chromium in the base material.

5. The method of claim 4 wherein the amount of chromium in the base material is less than about 4.1% chromium.

6. The method of claim 1 wherein the base material is selected from the group consisting of M3 and higher grade high speed steels; T4 and higher grade high speed steels; higher grade hot forming and die casting steels including H10, H11, H12, H19, H21, P20, Shell-X, FX, and CX; and cold forming steels.

7. A method for diffusing titanium and nitride into a base material comprising:
providing a base material comprising a steel or steel alloy,
altering the composition of the base material such that the base material comprises less than about 4.1% chromium;
providing a salt bath which includes sodium dioxide and a salt selected from the group consisting of sodium cyanate and potassium cyanate;
dispersing metallic titanium formed by electrolysis of a titanium compound, in said bath;
heating the salt bath to a temperature ranging from about 430° C. to about 670° C.; and
soaking the material in the salt bath for a time of from about 10 minutes to about 24 hours.

8. The method of claim 7 further comprising the step of limiting the amount of chromium in the base material in order to facilitate diffusion of titanium and nitride into the base material.

9. The method of claim 7 further comprising the step of altering the composition of the base material such that the base material further comprises cobalt, and wherein the presence of cobalt in the base material facilitates the diffusion of titanium and nitride into the base material.

10. The method of claim 7 further comprising the step of increasing the amount of vanadium in the base material in order to in the base material facilitates the diffusion of titanium and nitride into the base material.

11. The method of claim 10 wherein the amount of vanadium in the base material is more than about 1.95% vanadium.

12. The method of claim 7 wherein the base material is selected from the group consisting of M3 and higher grade high speed steels; T4 and higher grade high speed steels; higher grade hot forming and die casting steels including H10, H11, H12, H19, H21, P20, Shell-X, FX, and CX; and cold forming steels.

13. A method for diffusing titanium and nitride into a base material comprising:
providing a base material comprising a steel or steel alloy,
altering the composition of the base material such that the base material comprises cobalt;
providing a salt bath which includes sodium dioxide and a salt selected from the group consisting of sodium cyanate and potassium cyanate;
dispersing metallic titanium formed by electrolysis of a titanium compound, in said bath;
heating the salt bath to a temperature ranging from about 430° C. to about 670° C.; and
soaking the material in the salt bath for a time of from about 10 minutes to about 24 hours.

14. The method of claim 13 further comprising the step of limiting the amount of chromium in the base material in order to facilitate diffusion of titanium and nitride into the base material.

15. The method of claim 13 further comprising the step of increasing the amount of vanadium in the base material in order to in the base material facilitates the diffusion of titanium and nitride into the base material.

16. The method of claim 15 wherein the amount of vanadium in the base material is more than about 1.95% vanadium.

17. The method of claim 13 wherein the base material is selected from the group consisting of M3 and higher grade high speed steels; T4 and higher grade high speed steels; higher grade hot forming and die casting steels including H10, H11, H12, H19, H21, P20, Shell-X, FX, and CX; and cold forming steels.

18. A treated article comprising:
a base material comprising a steel or steel alloy, said base material comprising more than about 1.95% vanadium or a presence of cobalt;
a titanium component diffused into the base material; and
said titanium component is in addition to any titanium present in the base material.

19. The treated article of claim 18, wherein the base material further comprises less than about 4.1% chromium.

20. The treated article of claim 18 wherein the base material is selected from the group consisting of M3 and higher grade high speed steels; T4 and higher grade high speed steels; higher grade hot forming and die casting steels including H10, H11, H12, H19, H21, P20, Shell-X, FX, and CX; and cold forming steels.

21. A treated article comprising:
a base material comprising a steel or steel alloy, said base material comprising at less than about 4.1% chromium;
a titanium component diffused into the base material; and
said titanium component is in addition to any titanium present in the base material.

22. The treated article of claim 21, wherein the base material further comprises cobalt.

23. The treated article of claim 21, wherein the base material further comprises more than about 1.95% vanadium.

24. The treated article of claim 21 wherein the base material is selected from the group consisting of M3 and higher grade high speed steels; T4 and higher grade high speed steels; higher grade hot forming and die casting steels including H10, H11, H12, H19, H21, P20, Shell-X, FX, and CX; and cold forming steels.
